(19) United States
(12) Patent Application Publication
(10) Pub. No.: US 2008/0118905 A1
(43) Pub. Date: May 22, 2008

(54) Interactive lecture support system

(75) Inventor: Shinya Itou, Tokyo (JP)

Correspondence Address: RABIN & Berdo, PC, 1101 14TH STREET, NW, SUITE 500, WASHINGTON, DC, 20005, US

(73) Assignee: Oki Electric Industry Co., Ltd., Tokyo (JP)

(21) Appl. No.: 11/907,329

(22) Filed: Oct. 11, 2007

(30) Foreign Application Priority Data
Nov. 16, 2006 (JP) 2006-310537

(51) Int. Cl. G09B 3/00

(52) U.S. Cl. 434/350

(57) ABSTRACT

This system supports an interactive lecture performed between a plurality of student terminals and a plurality of instructor terminals by enabling bi-directional conversation between the student terminals and instructor terminals. An instructor selection menu is distributed to the student terminals so that each student can issue an instructor selection command to select an instructor. A conversation session for the bi-directional conversation is established between the selected one of the instructor terminals and a student terminal that has issued the instructor selection command.

### BACKGROUND OF THE INVENTION

1. Field of the Invention

The present invention relates to an interactive lecture support system for supporting an interactive lecture including an Internet English conversation lesson, for example, that is performed between a student terminal and a teacher terminal by enabling bi-directional conversation between the terminals via a network, such as the Internet.

2. Description of the Related Art

In the case of a conventional Internet English conversion lesson, a user checks the instructor introduction information on a Web site, and applies for a lecture. The application form specifies a desired instructor. Then, the user receives the English conversation lesson via an online bi-directional conversation with this instructor using such a communication device as a soft phone. Therefore, the user has to perform a plurality of steps until the user receives the English conversation lesson.

The reason why such a plurality of steps is required to start an English conversation lesson is because smooth linking or co-operating scheme is not established between a WWW (World Wide Web) environment, which is a server-client configuration using an HTTP protocol for implementing home page distribution, and an SIP environment, which is a peer-to-peer configuration using SIP (Session Initiation Protocol) for implementing VoIP (Voice Over Internet Protocol). In the case of an English conversation lesson, an application program (AP) for introducing instructors to a user is run in the WWW environment, but an application program for providing a conversation function which allows conversation online runs in the SIP environment. A method of implementing an application program in the SIP environment is, for example, JSR 116: SIPServlet API (Application Program Interface), disclosed in http://jcp.org/aboutJava/communityprocess/final/jsr116/index.html. It should be noted that WWW may be simply referred to as “Web” in the following description and accompanying drawings.

Therefore, with a conventional configuration, smooth operation cannot be implemented.

### SUMMARY OF THE INVENTION

It is an object of the present invention to provide an interactive lecture support system which enables smooth linking between information distribution (e.g., distribution of instructor introduction information) and instructor-student conversation (bi-directional conversation).

According to one aspect of the present invention, there is provided an improved system for supporting an interactive lecture performed between a plurality of student terminals and a plurality of instructor terminals by enabling bi-directional conversation between the student terminals and instructor terminals. The interactive lecture support system includes an instructor selection menu distribution unit for distributing an instructor selection menu to the student terminals. The interactive lecture support system also includes a conversation session establishment unit for establishing a conversation session for the bi-directional conversation between an instructor terminal belonging to the selected instructor and one of the student terminals that issues an instruction selection command. This student selects a particular instructor by issuing the instruction selection command using the instructor selection menu.

This interactive lecture support system realizes smooth linking between information distribution (e.g., distribution of instructor introduction information) and instructor-student conversation (bi-directional conversation).

These and other objects, aspects and advantages of the present invention will become apparent to those skilled in the art from the following detailed description, when read and understood in conjunction with the appended claims and accompanying drawings.

### BRIEF DESCRIPTION OF THE DRAWINGS

FIG. 1 illustrates a general block diagram of an English conversation lesson providing system that is one embodiment of an interactive lecture support system according to the present invention;

FIG. 2 is a block diagram depicting a detailed configuration of an SIP environment and a WWW environment shown in FIG. 1;

FIG. 3 is a block diagram depicting a detailed configuration of a presence management shown in FIG. 2;

FIG. 4 is a block diagram depicting a detailed configuration of a signaling management shown in FIG. 2;

FIG. 5 is a block diagram depicting a detailed configuration of a call management shown in FIG. 2;

FIG. 6 is a block diagram depicting a configuration of a matching AP (application program) shown in FIG. 2;

FIG. 7A shows the relationship between the priority set by an operator and the priority set by a student;

FIG. 7B shows the evaluation of a student by an instructor;

FIG. 7C shows the evaluation of an instructor by a student;

FIG. 8A shows an example of the contents of a student database;

FIG. 8B shows an example of the contents of an instructor database;

FIG. 8C shows an example of the contents of a state management database;

FIG. 9 is a diagram depicting an operation sequence from making of a search request to displaying of a search result when a student selects an instructor;

FIG. 10 depicts an operation sequence from an instructor selection based on the search result to a start of a conversation session;

FIG. 11 depicts an operation sequence from a disconnection of a conversation session at an end of a lecture to an evaluation result registration; and

FIG. 12 shows an example of a screen display which is displayed on a WWW browser of a user who becomes a student.

### DETAILED DESCRIPTION OF THE INVENTION

Embodiments of the present invention will now be described with reference to the accompanying drawings.

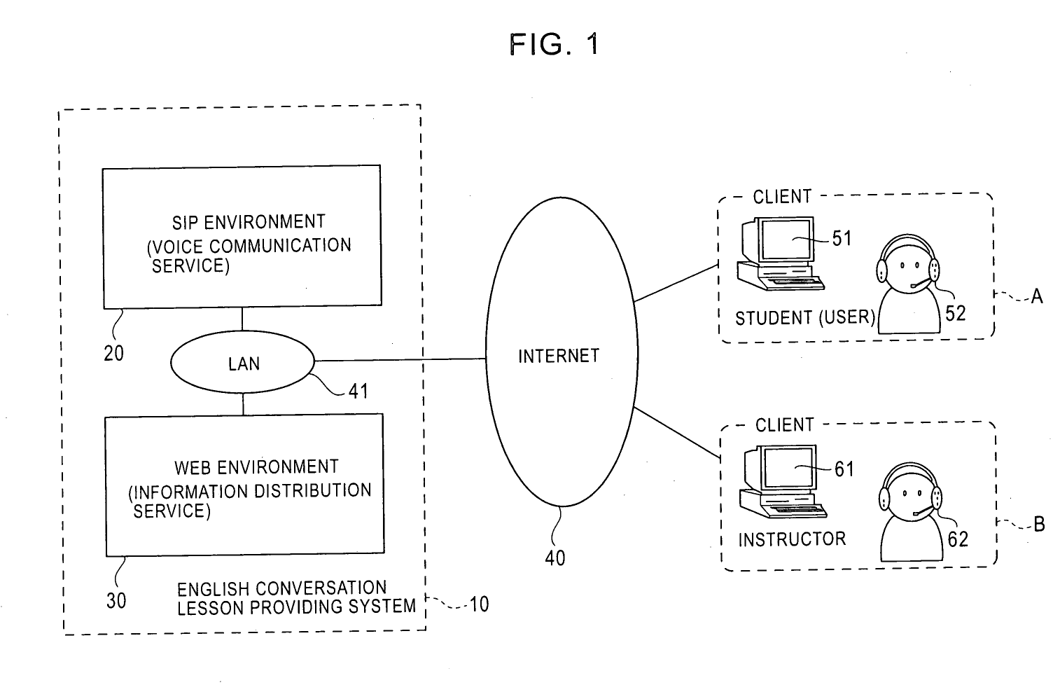

Referring to FIG. 1, a general configuration of an English conversation lesson providing system 10 is described. The English conversation lesson providing system 10 is an example of an interactive lecture support system according to the present invention. This system 10 provides English conversation lessons to users (i.e., students) via the Internet 40. This system 10 implements an Internet English conversation service which matches instructors who reside worldwide and who can teach English, and students who want to learn English conversation, on a WWW site. Thus, the system 10 can provide quality English conversation lessons.

As shown in FIG. 1, a user who becomes a student receives information distributed from a WWW site using a WWW browser 51 included in a client A, and also receives a voice communication service provided via a soft phone 52 included in the client A. An instructor who provides a lesson to the student receives information distributed from a WWW site using a WWW browser 61 included in a client B, and receives a voice communication service provided via a soft phone 62 included in the client B. In the illustrated embodiment, the client A is a student terminal and the client B is the instructor terminal, but the present invention is not limited in this regard. For example, two or more clients A may be connected to a single client B via the Internet 40, or two or more clients A may be connected to two or more clients B via the Internet 40, or a single client A may be connected to two or more clients B via the Internet 40.

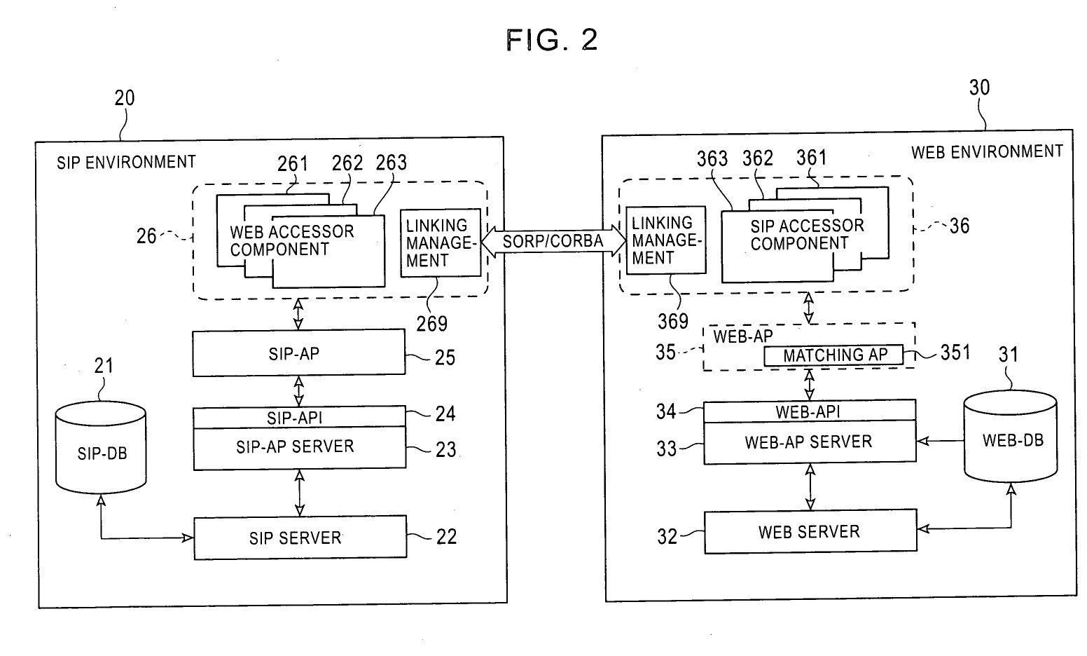

The WWW browsers 51 and 61 are client environments which are connected to a WWW server 32 located in a WWW environment 30 (FIG. 2) of the system 10 for using the functions provided by a WWW-AP 35 in the WWW environment 30. The soft phones 52 and 62 are SIP-compatible IP telephone terminals, and are connected with the SIP environment 20 of the system 10 via the Internet 40.

The English conversation lesson providing system 10 has the SIP environment 20, which is a first communication environment, and the WWW environment 30, which is a second communication environment. The environments 20 and 30 are connected to each other via a LAN 41, and also connected to the Internet 40 via the LAN 41. It should be noted that the SIP environment 20 and the WWW environment 30 may be directly (not via the LAN 41) connected to the Internet 40. In other words, the SIP environment 20 and the WWW environment 30 may be located in network environments that belong to different network domains, or both of the SIP environment 20 and the WWW environment 30 may be located in a same server computer device.

Referring to FIG. 2, a detailed configuration of the SIP environment 20 and the WWW environment 30 will be described.

### <Configuration of the SIP Environment 20>

An SIP server 22 is a server which handles and manages an SIP based on RFC 3261, for example, specified by IETF, and has an SIP proxy server function, SIP registrar server function and SIP location server function. The SIP proxy server function is a function to relay an SIP message as a representative of the client. The SIP registrar server function is a function to manage the registration of clients. The SIP location server function is a function to manage such information as the address information of registered clients.

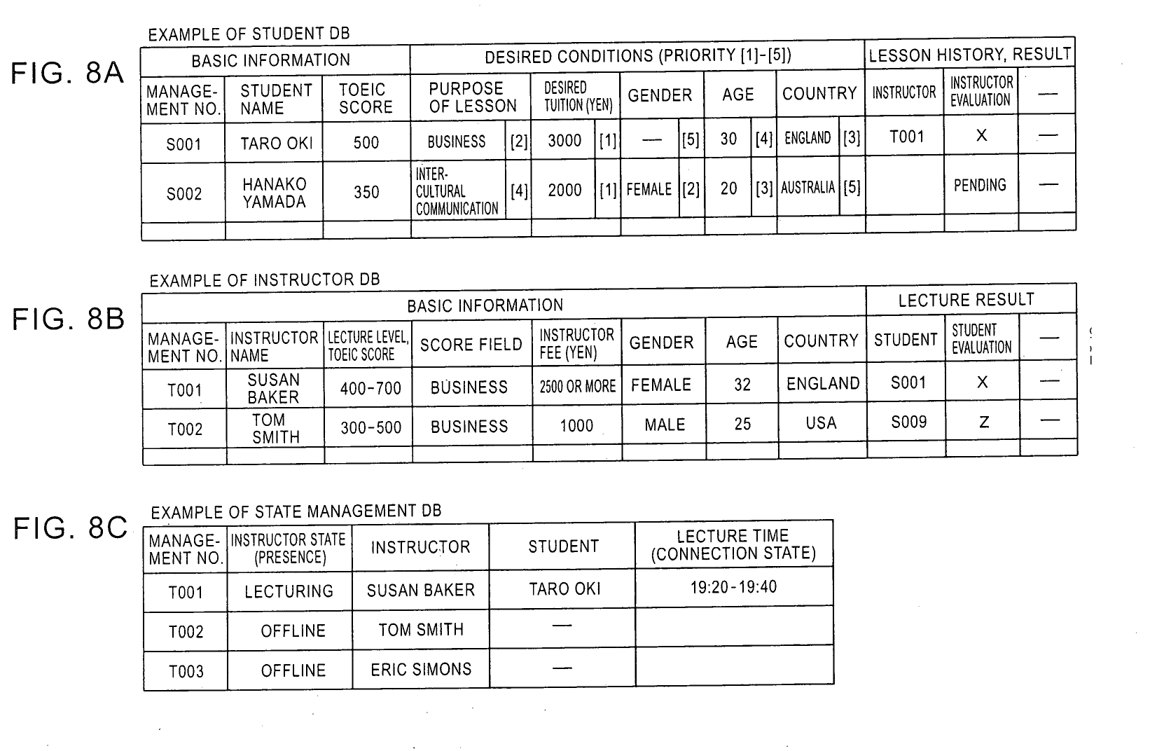

An SIP-DB 21 is a database for storing state management database managed by the SIP server 22, such as user information, presence information and instructor state information (see FIG. 8C). The user information here is the address information of clients, such as students and instructors, and information for authentication. The presence information is information to indicate the client state, such as whether the client is being connected or whether the client is activated or in use or is connected with another client. The instructor state is the SIP related information managed by a matching AP. The presence of an instructor and lecture history are information on the connection state between instructors and users, and communication history.

An SIP-AP server 23 is a server for running an AP to operate SIP protocol which is managed by the SIP server 22. The SIP-AP server 23 controls SIP requests received by the SIP server 22, such as session establishment, acknowledgment response, conversation termination and presence change. The SIP-AP server 23 also issues requests to an SIP server 22.

An SIP-API 24 is an AP interface provided by the SIP-AP server 23, and is normally implemented by the SIP Servlet API, of which standardization is currently being promoted by JCP (Java Community Process). An SIP-AP 25 is an SIP-compatible AP (Application Program) which is constructed by the SIP-API 24, and runs on the SIP-AP server 23. The SIP-AP 25 includes an AP for implementing such features as an IP telephone, instant messaging, TV telephone and presence communication.

A WWW accessor component 26 is a general term for a plurality of components adapted to allow the SIP-AP 25 to link with the WWW environment 30, that is a general term for library software components. The WWW accessor component 26 includes a presence management 261, signaling management 262, call management 263 and linking management 269.

Presence management 261 is a component for operating and managing presence information, which is managed in the SIP environment 20. Signaling management 262 is a component for operating and managing SIP signaling using the SIP server 22 of the SIP environment 20. Call management 263 is a component for operating and managing call status, which is managed in the SIP environment 20. Linking management 269 is a communication environment for accepting the access from the WWW environment 30 to the SIP environment 20 or the access from the SIP environment 20 to the WWW environment 30 by linking with a corresponding mechanism in the WWW environment 30. Linking management 269 is implemented using SOAP (Simple Object Access Protocol) or CORBA (Common Object Request Broker Architecture), for example.

### <Configuration of the WWW Environment 30>

The WWW server 32 is a server for handling and managing HTTP. A WWW-DB 31 is a database for storing information managed by the WWW server 32, such as an access log and student database and instructor database, on student information and instructor information for a matching AP, for example (see FIG. 8A and FIG. 8B). The student database constructs a table of student evaluation. In this table, each student name is associated with a student evaluation which is given by an instructor for that student. The instructor database constructs a table of instructor evaluation. In this table, each instructor name is associated with an evaluation given by a student.

The access log is information to indicate the state of WWW access. The student information is information managed by a matching AP, and has basic information including user name and TOEIC score, search conditions including the purpose of lessons, desired tuition, gender, age and nationality, and the lesson history including the instructor name and instructor evaluation. The instructor information is information managed by a matching AP, and has basic information including instructor name, lecture level and TOEIC score, search conditions including specialty field, desired tuition, gender, age and nationality, and lecture history including user and evaluation result.

A WWW-AP server 33 is a server for running the WWW protocol managed by the WWW server 32, that is the AP (Application Program) for operating HTTP, and can be implemented using TOMCAT from Open Source or WebLogic provided by BEA Co., for example. A WWW-API 34 is an AP interface provided by the WWW-AP server 33, and is normally implemented using an HTTP Servlet API specified in the J2EE (Java 2 Enterprise Edition) environment and EJB (Enterprise Java Beans).

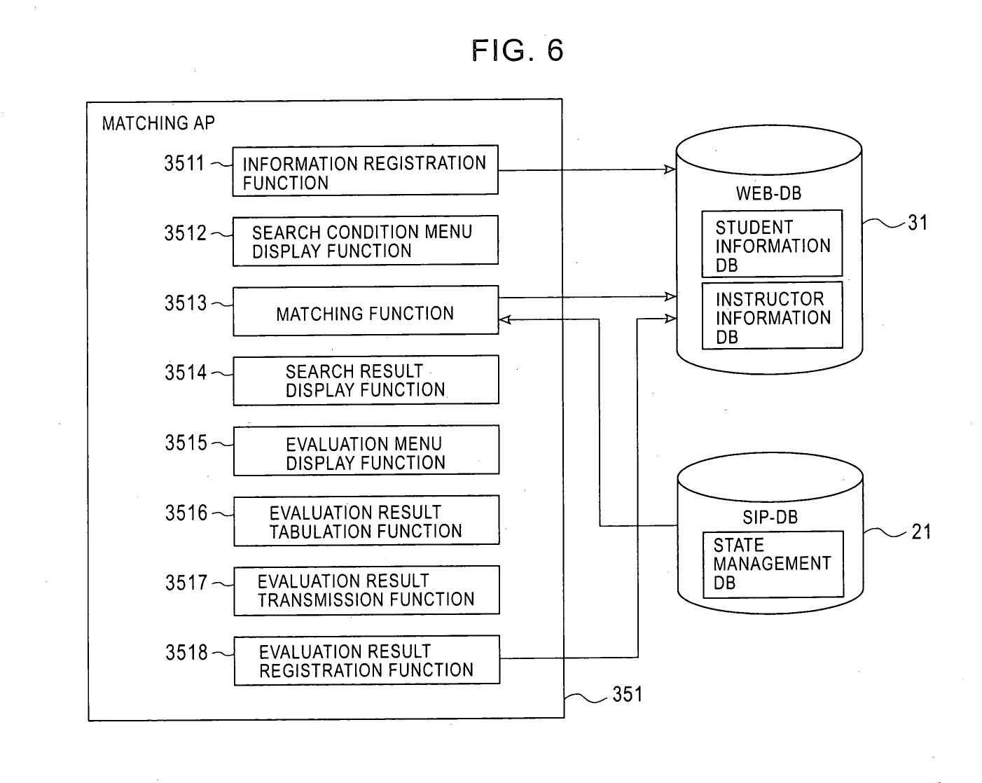

A WWW-AP 35 is a WWW-AP which is constructed by WWW-API 34, and runs on the WWW-AP server 217. The WWW-AP 35 includes a matching AP 226. The functions of the matching AP 226 will be described later with reference to FIG. 6.

The SIP accessor component 36 is a general term for a group of components adapted to allow the WWW-AP (Web-AP) 35 to link with the SIP environment 20, and is used by the WWW-AP 35 to perform the functions on the SIP environment 20, namely, to communicate with the WWW accessor component 26. The SIP accessor component 36 includes a presence management 361, signaling management 362, call management 363 and linking management 369.

Presence management 361 is a component in the WWW environment 30 for accessing the presence information managed in the SIP environment 20. Signaling management 362 is a component in the WWW environment 30 for accessing SIP signaling by using the SIP server 22 of the SIP environment 20. Call management 363 is a component in the WWW environment 30 for accessing the call state managed in the SIP environment 20.

Linking management 369 is a communication environment for accessing from the WWW environment 30 to the SIP environment 20 using the call management 223, or accessing from the SIP environment 20 to the WWW environment 30, by linking with a corresponding mechanism in the SIP environment 20. This communication environment can be implemented using SOAP (Simple Object Access Protocol) or CORBA (Common Object Request Broker Architecture) in accordance with the linking management 269 in the SIP environment 20.

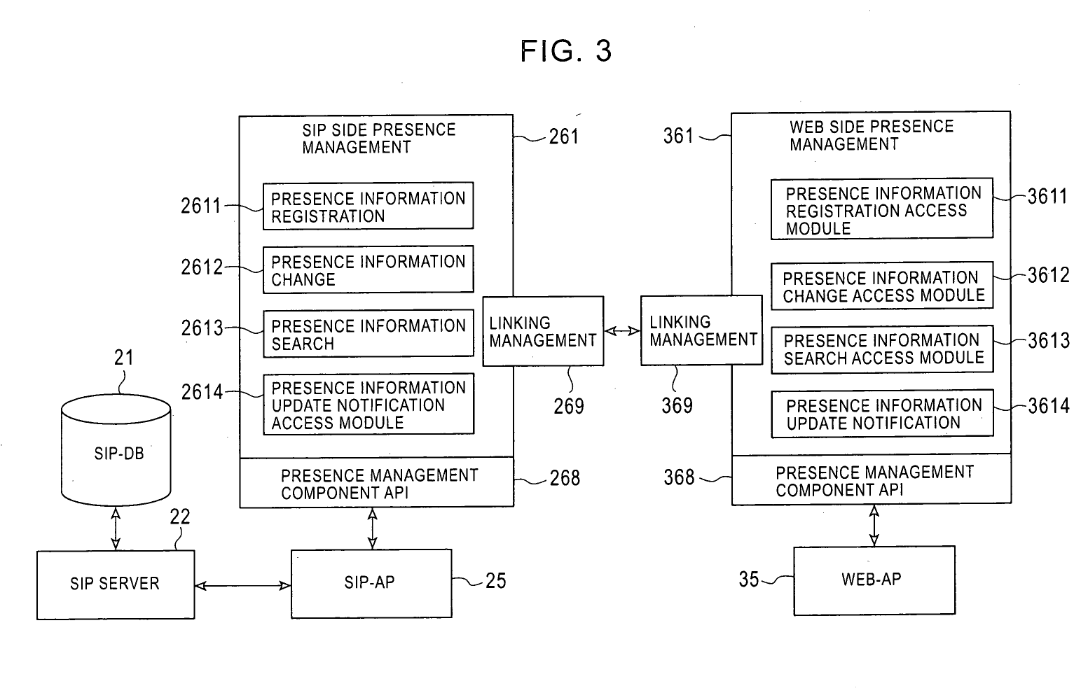

FIG. 3 shows a detailed configuration of the presence management 261 and the presence management 361 shown in FIG. 2. In the description below, it is assumed that the presence management 261 is the SIP side presence management 261, and the presence management 361 is the WWW side presence management 361. The component API 268 is an API (Application Program Interface) for allowing the SIP-AP 25 to access the presence management 261, and the component API 368 is an API for allowing the WWW-AP 35 to access the presence management 361.

The SIP side presence management 261 is a component for operating and managing the presence information managed on the SIP-DB 21. The SIP side presence management 261 includes a presence information registration 2611 for registering presence information, presence information change 2612 for changing registered presence information to the latest information, presence information search 2613 for searching registered presence information, and presence information update notification access module 2614 for notifying the latest presence information updated via the SIP server 22 to the WWW side presence management module 222.

The WWW side presence management 361 has modules for accessing each of the functions of the SIP side presence management 261 via communication between the linking management 269 and the linking management 369. The WWW side presence management 361 has a presence information registration access module 3611, presence information change access module 3612, presence information search access module 3613 and presence information update notification 3614. These modules implement access functions by linking with the corresponding functions in the SIP side presence management 261.

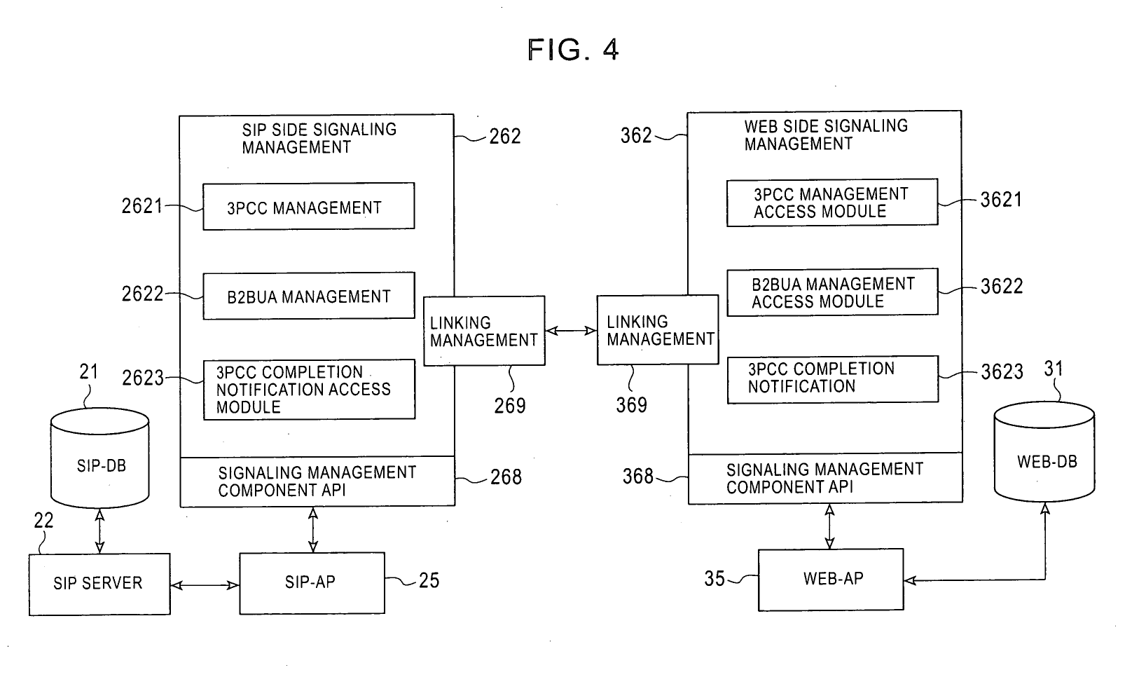

FIG. 4 shows the detailed configuration of the signaling management 262 and signaling management 362 shown in FIG. 2. In the description below, it is assumed that the signaling management 262 is the SIP side signaling management 262, and the signaling management 362 is the WWW side signaling management 362. The component API 268 is an API (Application Program Interface) for allowing the SIP-AP 25 to use the signaling management 262, and the component API 368 is an API for allowing the WWW-AP 35 to use the signaling management 362.

The SIP side signaling management 262 is a component for operating and managing SIP signaling using the SIP server 22. The SIP side signaling management 262 has a 3PCC (Third Parity Call Control) management 2621 for providing a communication function between two parties using the SIP server 22 so as to enable such an operation as Click-to-Dial, B2BUA (Back to Back User Agent) management 2622 for implementing communication between two parties as two separate SIP sessions, and a 3PCC completion notification access module 2623 for notifying completion of 3PCC executed via the SIP server 22 to the WWW side signaling management 362.

The WWW side signaling management 362 includes modules for implementing communication with each module in the SIP side signaling management 262 via the communication between the linking management 269 and linking management 369. The WWW side signaling management 362 has a 3PCC management access module 3621 for accessing the 3PCC management in the SIP side signaling management 262 from the WWW environment 30, a B2BUA management access module 3622 for accessing the B2BUA management in the SIP side signaling management 262 from the WWW environment 30, and a 3PCC completion notification 3623 for receiving an execution completion notice of the 3PCC management in the SIP side signaling management 262 and recognizing completion of execution of 3PCC requested from the WWW environment 30.

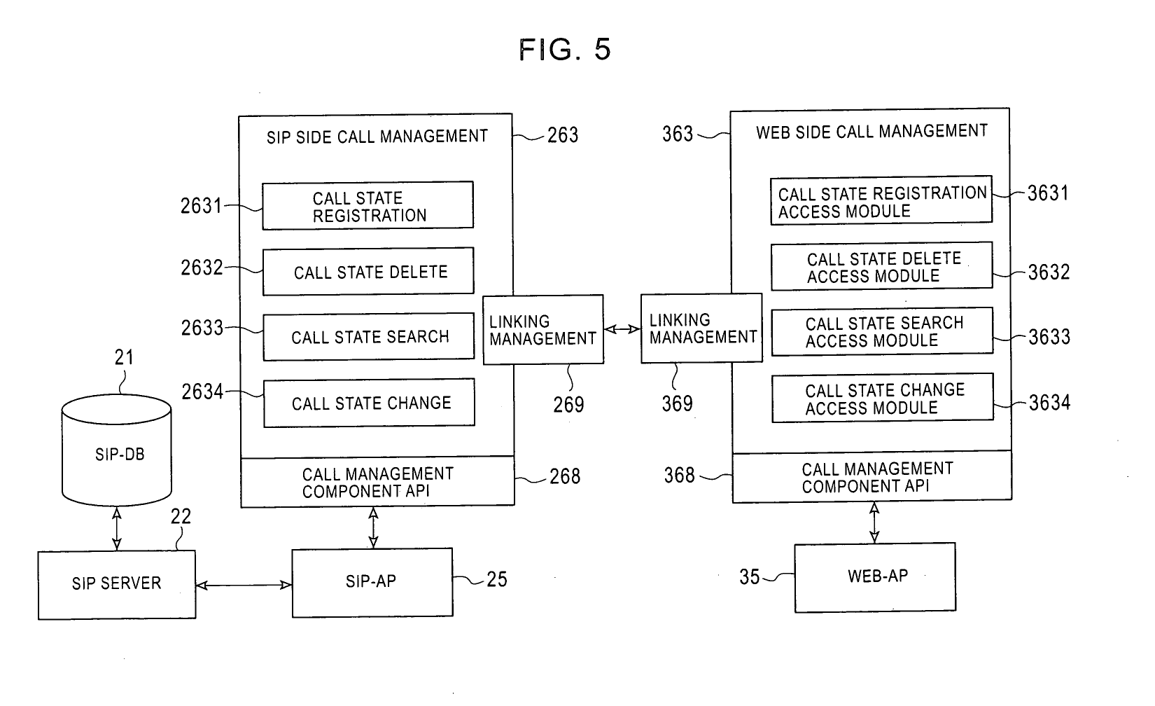

Referring to FIG. 5, the detailed configuration of the call management 263 and call management 363 shown in FIG. 2 is described. In the description below, it is assumed that the call management 263 is the SIP side call management 263, and the call management 363 is the WWW side call management 363. The component API 268 is an API (Application Program Interface) for allowing the SIP-AP 25 to access the call management 263, and the component API 368 is an API for allowing the WWW-AP 35 to access the call management 363.

The call management 263 is a component for operating and managing the call state based on the state management DB included in the SIP-DB 21. The call management 263 includes a call state registration 2631 for registering a call state, call state update 2632 for changing a registered call state to the latest information, call state search 2633 for searching a registered call state, and a call state delete 2634 for deleting a registered call state.

The WWW side call management 363 has modules for accessing each module in the call management 263 via communication between the linking management 269 and linking management 369. The WWW side call management 363 includes a call state registration access module 3631, call state update access module 3622, call state search access module 3633, and call state delete access module 3634, and implements the access function by linking with the corresponding function in the call management 263.

FIG. 6 shows the configuration of the matching AP 351. The matching AP 351 has an information registration function 3511, search condition menu display function 3512, matching function 3513, search result display function 3514, evaluation menu display function 3515, evaluation result tabulation function 3516, evaluation result transmission function 3517 and evaluation result registration function 3518. The matching AP 351 accesses the WWW-DB 31 including the student DB and instructor DB, and SIP-DB 21 including the state management DB.

The information registration function 3511 is a module for displaying a registration screen for an instructor and a registration screen for a user on the WWW browser, and registering information in the registered instructor information DB and registered user information DB. The search condition menu display function 3512 is a module for displaying a screen for allowing the user to enter search conditions.

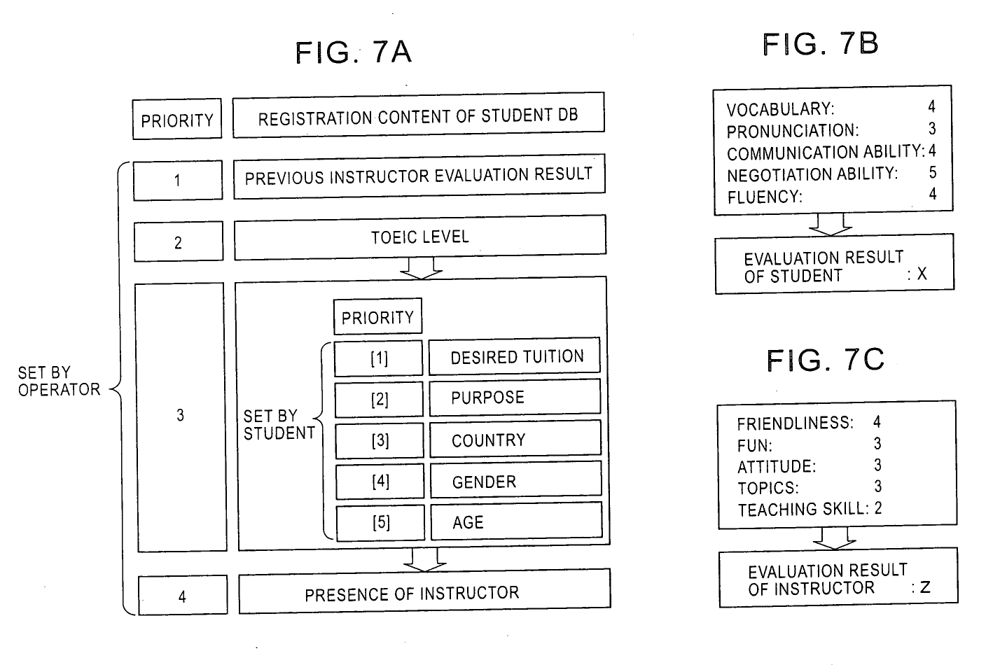

The matching function 3513 is a matching search module having a matching priority setting function, which lists the instructors from the registered instructor information DB in a priority set by the user. This priority is decided based on the student information DB of the WWW-DB registered by the user. The matching function 3513 also has a search function to extract the instructor presence information from the instructor information DB of the SIP-DB to pick out only online instructors who are available to provide lectures. The service provider (operator) of this English lesson can change or modify the priority if necessary. The user sets the priority when the user enters the search conditions (see FIG. 7A).

The search result display function 3514 is a module for displaying the search result by the matching AP on the WWW browser of the user. The evaluation menu display function 3515 is a module for displaying evaluation sheet input screens, to allow a user to evaluate an instructor, and to allow the instructor to evaluate the user, on the respective WWW browser when the session between the user and the instructor is disconnected.

The evaluation result tabulation function 3516 is a module to tabulate the evaluation result of the instructor by the user and the evaluation result of the user by the instructor, and can perform comprehensive judgment using various standards based on individual evaluation results (see FIG. 7B and FIG. 7C).

The evaluation result transmission function 3517 is a module for notifying the evaluation result of the instructor by the user to the instructor and the evaluation result of the user by the instructor to the user. The evaluation result registration function 3518 is a module for allowing the user and the instructor to register respective information in the WWW-DB by filling out and registering the information in the evaluation sheets.

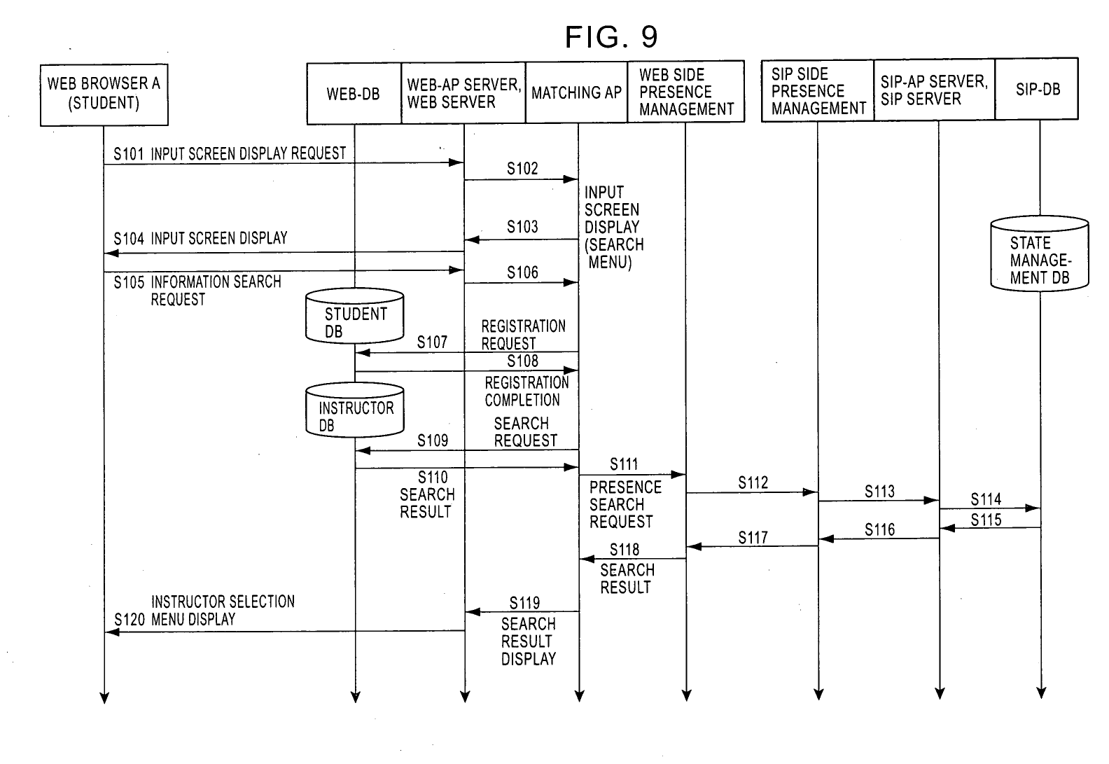

FIG. 9 shows an operation sequence from the search request to the display of the search result when selecting an instructor.

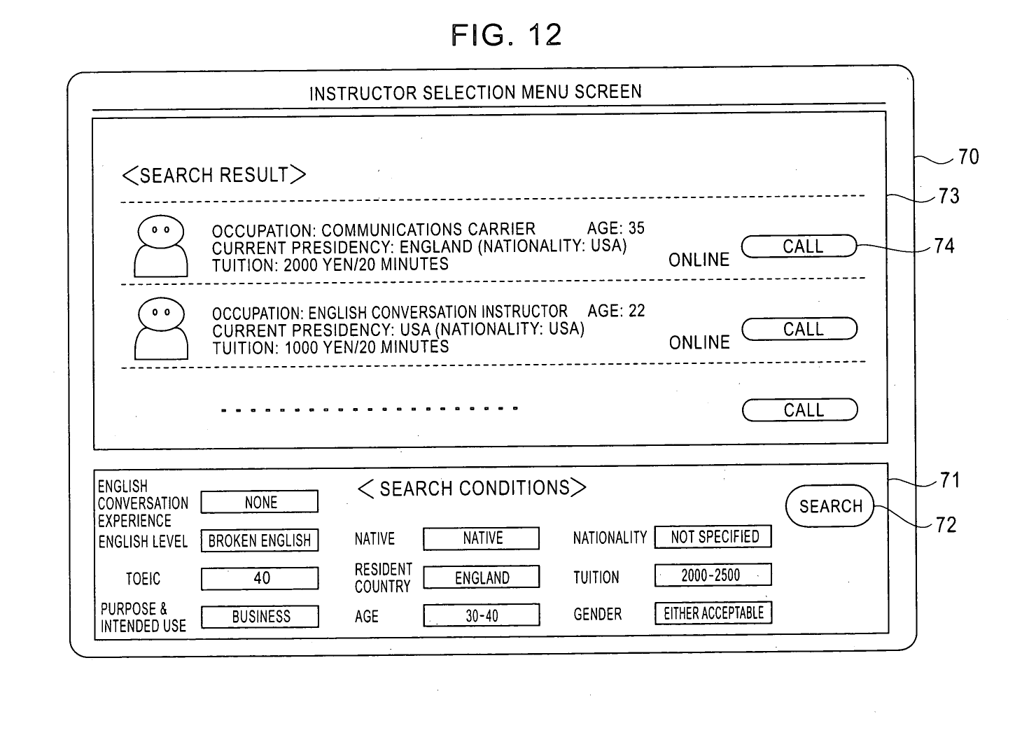

First the WWW browser A sends an entry screen display request for the matching AP to the WWW server/WWW-AP server according to the operation of the user (step S101). Then the WWW server/WWW-AP server sends the entry screen display request to the matching AP (step S102). The matching AP sends the requested entry screen (step S103). The WWW server/WWW-AP server displays the entry screen on the WWW browser A (step S104). On this entry screen 70, as shown in FIG. 12, input columns 71 for entering such search conditions as TOEIC score, purpose of taking lessons, tuition, and gender, age and nationality of instructor, and search button 72, are provided. It is preferable that priority can be specified on the input screen.

Then the WWW browser A requests to search instructor information according to the operation of the user (step S105). The information to be searched includes lecture level (converted to score of TOEIC), specialty field, tuition, gender, age and nationality of the instructors, and presence information of the instructors.

The matching AP receives the information search request from the WWW server/WWW-AP server (step S106). The matching AP registers the input information of the user in the student DB included in the WWW-DB (step S107). The student DB sends the registration completion result (step S108). The matching AP requests the instructor DB included in the WWW-DB to search according to the sequence of priority items based on the input information of the user using the priority setting function of the matching AP (step S109). When the search ends, the instructor DB sends the search result to the matching AP (step S110). By executing the steps S109 to S110 for the number of priority items, the instructor list is finally extracted.

Then the matching AP issues the presence “search request” for extracting instructors in an online state out of the instructor list to the WWW side presence management (step S111). The WWW side presence management links with the SIP side presence management to transfer the presence search request to the SIP side (step S112).

Then the SIP side presence management sends the search request to the SIP-AP server/SIP server (step S113). The SIP-AP server/SIP-server issues the search request to the SIP-DB (step S114). The state management DB included in the SIP-DB conducts a search to extract presence information of the registered instructors, and sends the search result to the SIP-AP server/SIP server (step S115). The SIP-AP server/SIP server notifies this search result to the SIP side presence management (step S116). The SIP side presence management links with the WWW side presence management to transfer this search result to the WWW side (step S117). This search result includes a list of instructors in an online state.

As a result, the search result corresponding to the above mentioned “search request” is received by the WWW side presence management. Then the WWW presence management returns this search result to the matching AP (step S118). The matching AP requests the WWW-AP server/WWW server to display the search result (step S119). Then the WWW-AP server/WWW server displays the search result on the online-state instructors matching this user on the WWW browser A of the user as the instructor selection menu (step S120). In this state, as shown in FIG. 12, if the user clicks on a certain call request button 74 which corresponds to one of the instructors in the instructor list of the search result 73, a call request to this instructor is issued. Instead of clicking on the call request button 74, the call request may be made by clicking on a displayed picture or name of that instructor.

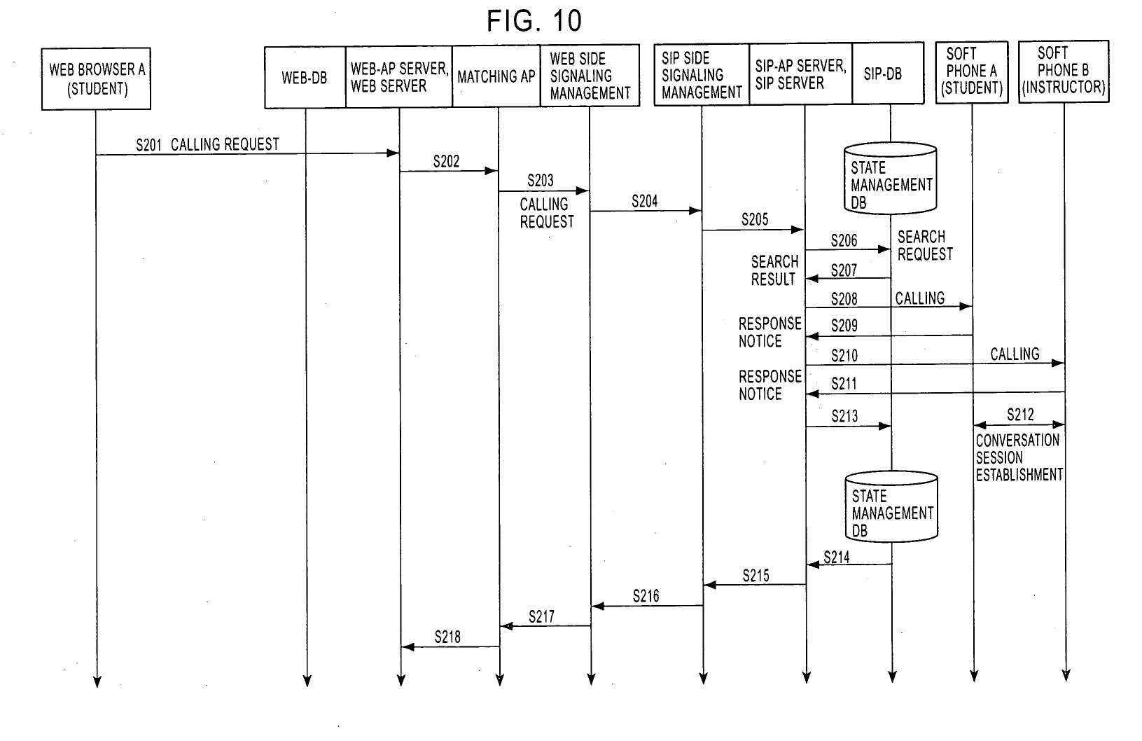

FIG. 10 shows an operation sequence from the instructor selection based on the search result to the start of the conversation session.

First the WWW browser B sends the call request to the WWW server/WWW-AP server upon the user's clicking on the call request button displayed on the WWW browser B (step S201). The matching AP receives this call request from the WWW server/WWW-AP server (step S202). The matching AP issues the “call request” to the WWW side signaling management (step S203). The WWW side signaling management links with the SIP side signaling management to transfer this “call request” to the SIP side by (step S204).

Then the SIP side signaling management sends the request to search for the telephone numbers of two parties to be connected to the SIP-AP server/SIP server (step S205). The SIP-AP server/SIP server sends the search request to the state management DB included in the SIP-DB 25 (step S206). The state management DB searches for the telephone numbers of these two parties, and returns the search result to the SIP-AP server/SIP server (step S207).

Based on the search result from the state management DB, the SIP-AP server/SIP server calls up the soft phone A of the user (step S208), and receives the response notice from the soft phone A (step S209). Then the SIP-AP server/SIP server calls up the soft phone B of the instructor (step S210), and receives the response notice from the soft phone B (step S211). Thus, a conversation session for bi-directional conversation between the soft phone A and the soft phone B is established (step S212). Accordingly, the user can become a student and have voice communication for an English conversation lesson with an instructor.

In the meanwhile, the SIP-AP server/SIP server registers the session state between the soft phone A and soft phone B in the state management DB (step S213). Then this session status is recognized by the WWW server/WWW-AP server via steps S214 to S218.

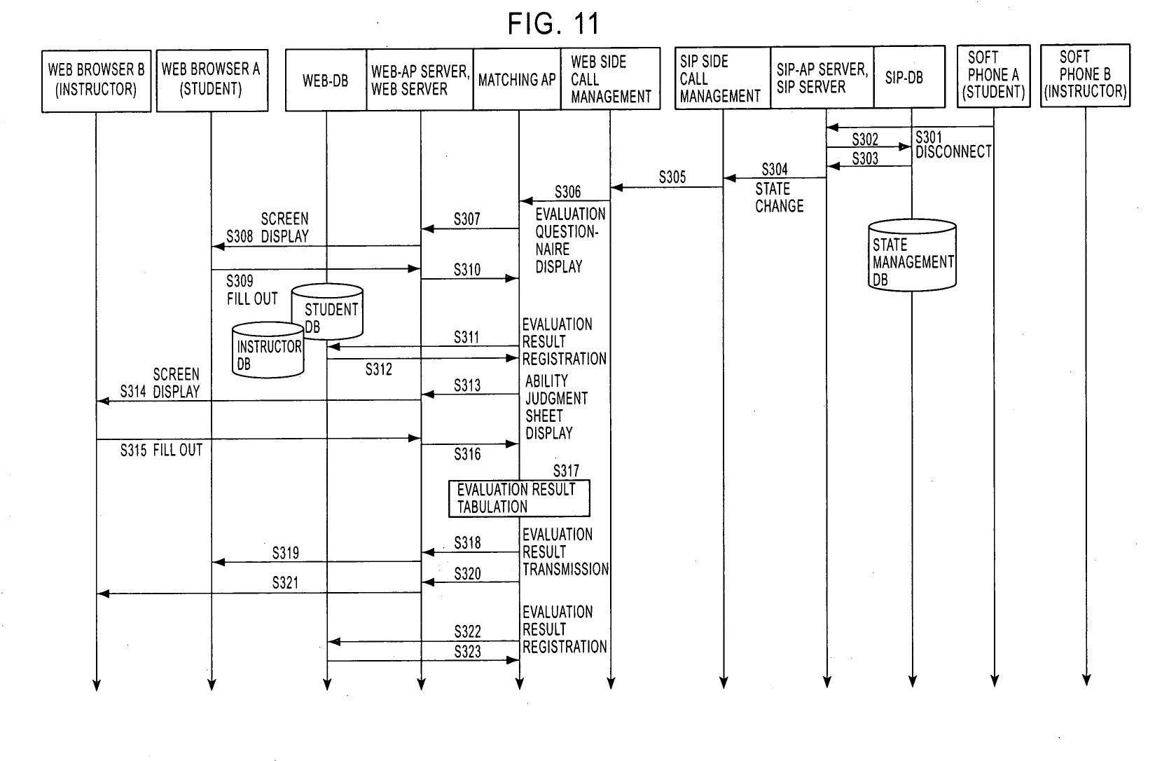

FIG. 11 shows the operation sequence from the disconnection of the conversation session, which occurs upon ending of the lecture, to evaluation result registration. Here it is assumed that such a lecture as an English conversation lesson is performed via the conversation session established by the above mentioned operation sequence, and the lecture is then completed.

First the SIP-AP server/SIP server receives the disconnection notice from the soft phone A of the user (step S301). Then the SIP-AP server/SIP server requests the state management DB included in the SIP-DB to change state (step S302). The state management DB changes the session state to disconnection state, and issues the change completion notice to the SIP-AP server/SIP server (step S303). Based on the changed result of the state management DB, the SIP-AP server/SIP server sends the “state change” notice to the SIP side call management (step S304). The SIP side call state management transfers this “state change” to the WWW side by linking with the WWW side call management (step S305).

Then the WWW side call management sends this “state change” to the matching AP (step S306). The matching AP requests the WWW-AP server/WWW server to display an evaluation questionnaire on the instructor, for example (step S307). The WWW-AP server/WWW server changes the display of the WWW browser A according to this display request (step S308).

If the user fills out the evaluation questionnaire displayed on the WWW browser A according to the changed display content, and clicks on the send button, the WWW browser A sends the WWW-AP server/WWW server a request to register the evaluation result based on the answered evaluation questionnaire (step S309). The WWW-AP server/WWW server issues this registration request to the matching AP (step S310). The matching AP requests the user DB and the instructor DB to register the evaluation results (step S311). The user DB and the instructor DB perform the requested registration, and issue the registration completion notices to the matching AP, respectively (step S312).

Then the matching AP requests the WWW-AP server/WWW server to display an ability judgment sheet, for example (step S313). The WWW-AP server/WWW server changes the display of the WWW browser B to the display of the ability judgment sheet (step S314). If the instructor fills out the ability judgment sheet displayed on the WWW browser B, and clicks on the send button, the WWW browser B sends the WWW-AP server/WWW server a request to register the evaluation result based on this ability judgment sheet (step S315). The WWW-AP server/WWW server issues this registration request to the matching AP (step S316).

Then the matching AP tabulates the evaluation result of the instructor by the user and the evaluation result of the user (student) by the instructor by various methods respectively, using the evaluation result tabulation function thereof (step S317). The evaluation result of the student by the instructor is represented by, for example, X (very good), Y (good) or Z (not very good), which is given based on certain standards, for the scores of vocabulary, pronunciation, communication ability, negotiation ability and fluency, for example. The evaluation result of the instructor by the student is also represented by X, Y or Z, based on certain standards, for the scores of friendliness, fun, attitude, topics and teaching skill, for example. A check box may be created for rejecting (refusing) future lessons of a specific instructor, so that this refusal is reflected in the search conditions to be used the next time.

Then the matching AP requests the WWW-AP server/WWW server to display the tabulated evaluation result on the WWW browser A (step S318). The WWW-AP server/WWW server displays this evaluation result on the WWW browser A which the student is using (step S319). In the same way, the matching AP requests the WWW-AP server/WWW server to display the tabulated evaluation result on the WWW browser B (step S320). The WWW-AP server/WWW server displays the evaluation result on the WWW browser B which the instructor is using (step S321). In the meanwhile, the matching AP requests the student DB to register this evaluation result (step S322). The student DB registers this evaluation result, and issues the registration completion notice to the matching AP (step S323).

The registered evaluation results of the student and the instructor are reflected in the search conditions to be used in the next search, and also become information to be displayed in the instructor selection menu.

In the above described embodiment, an AP constructed in the WWW environment and an AP constructed in the SIP environment can be inter-linked so that construction, execution and operation of a WWW-VoIP integrated AP is easily implemented.

Thus, application of the present invention will provide advantages in various aspects.

First, information leakage can be prevented, which improves usability. By using 3PCC (third Party Call Control) technology, the user can have an Internet English conversation with an instructor merely by clicking on the WWW screen. The instructor and the user need not divulge telephone numbers to each other. Thus, problems between the instructor and user (student) can be prevented and leakage of personal information between parties can also be prevented.

Second, the presence of registered instructors, information on instructors, and information and requests of the user are collated, and the system displays a list of optimum instructors who are currently available to provide lessons to a user. Thus, the user can easily search for the most suitable instructor at this point. This is a new service, which is not available in conventional conversation-lesson providing systems.

Third, there is provided an automated mechanism in which an instructor and user can mutually evaluate each other when a lesson is over, and this evaluation result is reflected in a database. Thus, the more the system is used, the more the accuracy of matching improves. Accordingly, a more suitable instructor list can be provided. This is another new service, which is not available in conventional conversation-lesson providing systems.

By integrating the instructor evaluation function, the student can evaluate the tuition decided by the instructor. This allows the lecture fee to be decided subject to market forces. In other words, if an instructor provides good lessons, a student will take it even if tuition is high. This means that an auction type personal English conversation school, for example, can be implemented.

Fourth, the competitive power of an interactive lesson providing company is strengthened since productivity improves. For example, information on the access between instructors and users, such as date and time, can be managed by an SIP server. Thus, instructors can be prepared according to the season and time, and an optimum number of instructors to be hired can be estimated, whereby employment can be optimized and productivity can be improved.

In the above-described embodiment, an example of a method for integrating an SIP-AP and WWW-AP is described, but the present invention can be applied to the integration of various and different protocols. Also, the illustrated embodiment deals with an Internet English conversation service, but the present invention can be used for other services. For instance, the present invention can create a service of matching individuals with special skill and individuals who wish to learn that skill, connecting both parties via voice and images. Thus, the present invention can be used for private Internet tutors and an Internet piano school.

This application is based on Japanese Patent Application No. 2006-310537 filed on Nov. 16, 2006 and the entire disclosure thereof is incorporated herein by reference.

What is claimed is:

1. An interactive lecture support system for supporting an interactive lecture performed between a plurality of student terminals and a plurality of instructor terminals by enabling bi-directional conversation between the student terminals and instructor terminals, the system comprising:
an instructor selection menu distribution unit for distributing an instructor selection menu to one of the student terminals; and
a conversation session establishment device for establishing a conversation session for the bi-directional conversation between a selected one of the instructor terminals and said one of the student terminals, wherein the selected one of the instructor terminals is decided by an instructor selection command transmitted from said one of the student terminals.

2. The interactive lecture support system according to claim 1, wherein the instructor selection menu distribution unit extracts instructor terminals belonging to instructors who can give lectures out of the instructor terminals and creates the instructor selection menu which lists instructors of the extracted instructor terminals as choices.

3. The interactive lecture support system according to claim 1, wherein the instructor selection menu distribution unit searches at least one instructor matching search conditions supplied from said one of the student terminals such that the instructor selection menu includes the searched instructors as choices.

4. The interactive lecture support system according to claim 3, wherein the instructor selection menu distribution unit searches said at least one instructor according to pre-registered priority conditions.

5. The interactive lecture support system according to claim 1, further comprising:
a student evaluation tabulation unit for tabulating student evaluation supplied from the instructor terminals for a student who operates said one of the student terminals; and
a student evaluation table showing relationship between the instructors and the student evaluation updated by the tabulated student evaluation, wherein the instructor selection menu distribution unit searches for at least one instructor suited for the student who operates to said one of the student terminals from the student evaluation table, and creates the instructor selection menu that includes the searched instructors as choices.

6. The interactive lecture support system according to claim 1, comprising:
an instructor evaluation tabulation unit for tabulating instructor evaluation supplied from the student terminals for each instructor; and
an instructor evaluation table showing relationship between students who operate the student terminals and the instructor evaluation updated by the tabulated instructor evaluation, wherein the instructor selection menu distribution unit searches for at least one instructor suited for the student who operates said one of the student terminals from the instructor evaluation table, and creates the instructor selection menu that includes the searched instructors as choices.

7. The interactive lecture support system according to claim 1, wherein the instructor selection menu distribution unit distributes the instructor selection menu in a server-client type first communication environment, and
the conversation session establishment device establishes the conversation session in a peer-to-peer type second communication environment, by linking to the instructor selection command supplied in the first communication environment.

8. The interactive lecture support system according to claim 1, wherein the conversation session establishment device establishes the conversation session by calling both said one of the student terminals and the selected one of the instructor terminals.

9. The interactive lecture support system according to claim 7, wherein the server-client type first communication environment is a WWW environment and the peer-to-peer type second communication environment is an SIP environment.

10. The interactive lecture support system according to claim 1, wherein the conversation session establishment device establishes the conversation session without exchanging telephone numbers between the selected one of the instructor terminals and said one of the student terminals.

11. The interactive lecture support system according to claim 1, wherein the interactive lecture is an English conversation lecture.
